(19) United States
(12) Patent Application Publication
(10) Pub. No.: US 2012/0201664 A1
(43) Pub. Date: Aug. 9, 2012

(54) Water born rotor mechanism adapted for generating power

(76) Inventor: Robert J. McCants, Toledo, OH (US)

(21) Appl. No.: 12/929,646

(22) Filed: Feb. 7, 2011

(51) Int. Cl. F03B 7/00

(52) U.S. Cl. 415/202

(57) ABSTRACT

The subject apparatus device which incorporates structural aspects of the invention herein is as an apparatus which is focused on a water flow or hydrostatic water pressure powered rotor mechanism, or other water means, such water driven rotor mechanism having a rotational member as installed within or adjacent to such mechanism in the water, such rotational member having water movement sensitive means to receive the impact of any oncoming water movement or water pressure, for generation of power, such water sensitive means generally being in the form of a rotor member for direct rotational drive of a shaft on which the rotor member is affixed herein, such rotor member being positioned facing generally the resultant oncoming water flow or water pressure, which leads to means to rotate a turbine, for ultimate generation of electrical or other forms of power.

### DISCUSSION OF PRIOR ART AND RELEVANT BACKGROUND

Energy conversion devices can potentially utilize water movement to drive a rotor mechanism for ultimate energy generation for usage in mechanical, electrical or other forms. Existing devices incorporating features to harness water power indirectly or directly to drive a turbine member or similar mechanism could be more economical if means are provided to enhance the water flow over a turbine member, such as placement of the turbine in an existing moving stream of water, as opposed to using a dam structure using the resultant water flow for driving turbines, or by using the hydrostatic pressure of a water body to convert to dynamic water flow.

More directly, appropriate means to utilize the driving force of natural water movement are not presently used to capture the potential energy in a natural water stream. More specifically, in this area of energy conversion, there are no effective devices structured to capture the maximum extent of natural water flow energy with ambient or existing flow of the water in a body of water so as to provide the drive force on a water driven rotor mechanism, thereby using the energy potential of existing water bodies, either from water flow pressure or hydrostatic water pressure.

With increasing emphasis on alternate energy sources, there is need therefore to more fully use natural water sources to realize energy potential in light of present climatology circumstances and energy conservation requirements.

Various designs of turbines are known for capturing useful energy from wind and water currents. These turbines typically, but not always, include a housing with an opening extending therethrough for receiving the fluid flow. Rotating blades are supported within the opening to drive a generator or the like using energy converted from the fluid flow impacting the turbine rotor blades. Energy from the surrounding fluid flow is typically not captured effectively and accordingly a low efficient results due to the lost energy not harnessed effectively, and therefore there is a need for a highly efficient structure to capture and use water sources for such need.

### SUMMARY AND OBJECTS OF INVENTION

The subject mechanism which incorporate structural aspects of the invention herein is as an apparatus which is focused on a water flow or hydrostatic water pressure powered rotor mechanism, such water driven rotor mechanism having a rotational member as installed within or adjacent to such mechanism, such rotational member having water movement sensitive means to receive the impact of any oncoming water movement, for generation of power, such water sensitive means generally being in the form of a rotor member for direct rotational drive of a shaft on which the rotor member is affixed herein, such rotor member being positioned facing generally the oncoming water flow which rotates a turbine member, for ultimate generation of electrical or other forms of power.

In view of the foregoing, it is an object of the subject invention to provide an improved energy conversion device, using natural water flow sources;

Yet another object of the subject invention is to provide an improved environmentally sound energy conversion system that is relatively pollution free;

Another object of the subject invention is to provide an improved apparatus to capture natural water flow for energy conversion purposes;

Still another object of the subjection invention is to provide a relatively efficient energy source;

A further object of the subject invention is to provide an improved apparatus for effectively using existing water sources, and dynamic and static forces of water in bodies of water, for energy conversion purposes;

It is also an object of the subject invention to provide an improved energy conversion mechanism, based on utilization of water flow in a body of water;

Yet another object of the subject invention is to provide a dynamic and continuously operated mechanism to increase the water flow over a water based turbine for purposes of generating more energy;

Still another object of the subject invention is to provide means to use hydrostatic water pressure in order to ultimately drive a water based or other turbine mechanism;

Other objects of the subject invention will become apparent from a reading of the description taken in conjunction with the claims.

In view of the foregoing objects, the subject invention incorporates structural means in the form a water powered rotor mechanism, such rotor mechanism optionally having a central rotational axle rotationally installed through and within or adjacent to an open stream or body of water and in same instances using a partially enclosed chamber member, to house the rotor-like turbine, with such turbine member having water movement sensitive means to receive the impact of any oncoming water flow, such water flow sensitive means generally being in the form of a turbine-like rotor member for direct rotational drive of the rotational axle in which the rotor member which can optionally be, but not in all situations in a partially or fully enclosed in a chamber, also potentially situated under water, or partially under water or close thereto, and wherein such frontal opening of such chamber leads into an elongated spatial area within such a chamber, such spatial chamber optionally extending away or downstream from the turbine rotor member. Alternately stated, the turbine-like rotor need not be situated in a housing and over the turbine and therefore in alternate embodiments, no chamber is used, although the main purpose of a housing chamber is to protect the turbine member and rotor from being damaged from free floating debris in the water body and in some situations to help accelerate water flow over the turbine. As stated in some embodiments, there is no chamber utilized.

In alternate embodiment of the subject invention, the water driven rotor device herein may be driven by the force of water generated by hydrostatic pressures, particularly hydrostatic pressure at lower levels of a body of water.

In summarizing the general embodiment of the subject invention it is important to note, as is well known, that water generated devices driven for energy purposes, are all subject to and dependent on the vagaries of water force at an given time. In some areas, there is no real effective economic output for energy generation from water flow or water movements caused by hydrostatic pressure. Because of seasonal differences in water flow volume flow away as in summer months water flow may diminish. For these reasons, the methodology herein can be deployed to increase water or water flow over the water turbine or rotors. In this light, the subject invention in some embodiments involves placement of a water turbine rotor in a chamber housing, with in the entrance opening of the chamber is faced upstream, and the exist opening downstream. The idea is to employ means to create a partial area of reduced pressure within the chamber so that water is more readily drawn into the chamber and over the water turbine because of the partial reduction of water pressure by means to increase the water flow velocity at the rear portion of the chamber. By the process it will increase the water flow into the chamber and thus over the water turbine rotor blades positioned at the front of chamber.

In order to accomplish increased-water flow over the water turbine rotor in one embodiment, a partial vacuum may be used in the chamber by one or more of the following physical features deployed within the chamber or by the very nature of the chamber structure itself, or other features not specifically delineated below:

(a) affixing one or more pumps or other means within the chamber near the middle or posterior portion of the chamber, although such pumps can be placed anywhere within the chamber to help create a partial water pressure reduction in such chamber;

(b) structuring the internal size and shape of the chamber of the chamber in such a manner so to create a Bernoulli effect as the water passes through the chamber to the exit opening of the chamber, to thereby accelerate the water flow through the chamber and create less water pressure in the posterior area of the chamber;

(c) other means to create a partial pressure reduction in the chamber to decrease water pressure in the rear of the chamber to increase water flow.

In embodiments using hydrostatic water pressure, a chambered like tube member projects either upwardly or downwardly from a collection point to be conveyed downwardly into a void, such as an underwater cavern or conversely upwardly above the water onto a barge or other floating member or above on the adjoining land areas.

While a chamber housing may be ideal for the housing of the turbine member it is to be indicated that in the alternative arrangement can be to place the turbine in the water without a protective housing, as described above. In some circumstances, off-shore means can be utilized that reach and extend outwardly over the water body, with turbine means thereon to support a downwardly extending turbine rotor member, which turbine is structured to extend downwardly into the water body. Other structural embodiments are envisioned herein. Thus, according to one embodiment of the present invention there is structured with a water driven turbine means for converting the energy of an underwater current, with a turbine comprising an elongated housing having a chamber extending therethrough in a longitudinal direction parallel to the water flow with an entry for receiving water and an exit end for releasing the water.

Moreover, the subject invention may comprise a structure to capture or utilize the hydrostatic water pressure in a body of water, that is the hydrostatic water pressure at levels below the upper surface in a water body, where the hydrostatic pressures are greater than at higher levels. In this latter embodiment, it is envisioned that the hydrostatic water pressures at such levels can be used if the water content at such level can be appropriately funneled upwardly, downwardly or laterally so that the flow of water resulting from such hydrostatic pressure is increased to drive a turbine.

### BRIEF DESCRIPTION OF THE DRAWINGS

FIG. 1 is a side elevational view of water turbine;

FIG. 2 is a perspective view of the subject invention;

FIG. 3 is an end elevational view of the subject invention; in section, showing the subject invention with the water turbine blades as being mounted in the water;

FIG. 5 is a cross view showing the subject device using the hydrostatic pressure;

FIG. 6 is a cross sectional view of another device using hydrostatic pressure.

### SUMMARY OF INVENTION AND GENERAL EMBODIMENTS

The subject apparatus device which incorporates structural aspects of the invention herein is as an apparatus which is focused on a water flow or hydrostatic water pressure powered rotor mechanism, or other water means, such water driven rotor mechanism having a rotational member as installed within or adjacent to such mechanism in the water, such rotational member having water movement sensitive means to receive the impact of any oncoming water movement or water pressure, for generation of power, such water sensitive means generally being in the form of a rotor member for direct rotational drive of a shaft on which the rotor member is affixed herein, such rotor member being positioned facing generally the resultant oncoming water flow or water pressure, which leads to means to rotate a turbine, for ultimate generation of electrical or other forms of power.

In summarizing the general embodiment of the subject invention it is important to note, as is well known that structural devices driven for energy purposes, are all subject to and dependent on the vagaries of water force at a given time. In some areas, there is no real effective economic output from water sources for energy generation, because of little or no water flow, unless there is a dam with substantially consistent water flow. Further, in summer months in many areas the waters diminish dramatically. For these reasons, the methodology herein is deployed to increase water flow over water turbine rotors in the path of the water flow. In this light, the reductions in the water flow at any given time in the concepts herein, involve placement of a water turbine rotor in a position at the lower levels of w water body, will ensure available water flow for a turbine, even during times of low water levels.

The subject device which incorporates structural aspects of the subject invention is thus focused on a water powered rotor mechanism, specifically utilizing energy from water sources such as water current movements or hydrostatic water pressure primarily under the water surface to provide energy to drive a rotor mechanism, such apparatus comprising in some embodiments in a general structural arrangement a longitudinally extending housing structure with an internal longitudinally extending chamber of some longitudinal extent, or having other holdings or protective structures for the turbine. Such structure has a water intake opening at some position for water intake generally positioned at the frontal or upstream portion of the housing chamber and a water outlet opening positioned between the frontal, upstream portion of the structure and downstream rear portion of the structure.

Such frontal opening in such structure communicates with water outside the chambered structure to the central longitudinally extending chamber that extends rearwardly towards the posterior part of the housing chamber. The longitudinal extending chamber in one embodiment is formed to help accelerate the rearwind flow of the water in the chamber to the downstream exit opening, with a progressively decreasing chamber circumference as the housing channel extends rearwardly to the exit opening of the chamber. This latter structure helps to accelerate water flow through such internal chamber.

To this end, the water driven rotor mechanism can be positioned at or near the frontal portion of the housing chamber. Such rotor mechanism has a central rotational axle rotationally installed longitudinally through such chamber or adjacent to such chamber, with the rotational axle having means thereon in certain embodiments to drive auxiliary pressure reduction pumps inside the chamber. In some embodiments as stated above, the housing chamber is formed with a gradually decreasing diameter or perimeter to help increase the water flow through the Bernoullie effect. By reason of the partial vacuum and/or increased water flow speed in such chamber, water flow will increase by some degree as it moves into such chamber in front of the opening in the housing chamber and this increase in flow into the chamber is caused basically by reduced pressure created in the chamber by the mechanisms or processes outlined above, thereby increasing the water flow speed over the water driven rotor as so positioned in the chamber. The water flow over the rotor, once having passed over the frontal opening of the chamber, will pass through the chamber in a longitudinal manner and thence through the gradually narrowing chamber as it flows to the exit opening of the chamber and such water flow will help accelerate the water flow as such water flow passes through the gradually decreased circumference of the chamber. As indicated, to some degree these latter structural and hydrodynamic phenomena will help create an increased water flow in the chamber the upper stream portion of the chamber and thus accelerate and increase water flow through the housing chamber. This latter phenomenon will cause a relative increase in water flow speed into the housing chamber at the frontal opening of the shroud chamber, near which is positioned the rotor turbine blades.

Thus, the idea herein is to employ means to create a an increase of water flow, relative to the normal flow of water in the particular body of water flow so that water is more readily drawn into the chamber because this in turn, will increase the water flow over the turbine blades and improve the efficiency of the water driven rotor member Additionally, the use of a housing chamber will decrease the chance of water born objects such as logs or other object striking against the rotor blades. A housing, with a chamber, for the water driven turbine can be avoided if there is alternate support and protection means for the turbine structure.

Alternately stated, the subject apparatus incorporating features of the subject invention is directed to a water powered rotor mechanism, preferably having an open chamber positioned over or near the water driven rotor, such apparatus comprising in its general form a shroud or housing member having a partially enclosed chamber with an water intake opening at the frontal end of such housing and an water exit opening at some other portion of the shroud. In this general embodiment of the subject invention, the turbine member is positioned in the water forward of any housing member, and not inside thereof. The opening end of the chamber or housing will be positioned ideally at or near the water driven rotor member. Thus, when oncoming water reaches and impacts against the water driver rotor frontally, such impacting water will thence substantially pass directly into the chamber housing, since the rotor will be ideally positioned just in front of entrance opening of the chamber, and as such water passes into the chamber it will be almost immediately be subjected to the gradually decreasing diameter of the chamber housing as water passes through such chamber. Such moving water in the chamber will increase the water flow into and intensity at or near the frontal end of the chamber and will create in effect of decreased water pressure in the rear portion of the chamber, and secondary turbines can be optionally positioned inside the housing. This will continue as water is pulled into the front of the chamber and thereby help increase the water flow continuously near the frontal rotor member outside the housing.

The housing chamber is exposed to outside water and for this purpose is ideally aligned parallel, as to its longitudinal central axis, to the direction of flow prevailing waters and is structurally adapted to admit water flow into the longitudinal extending chamber as aligned with the prevailing water flow. For this purpose the housing chamber can be mounted in a substantially horizontal plane about a vertical axis to be freely movable about such axis for alignment with the existing and potentially variable water direction. A portion of the chamber can be structured to receive and potentially support the water turbine rotor axle near the middle inside portion or other portions of the housing chamber, such rotor axle mechanism having a central rotational axle rotationally installed preferably along or parallel to the longitudinal central axis of such chamber, and extending longitudinally into such chamber with such rotor member anchored in such chamber for free rotational movement in such bearing member or members. As indicated, one or more secondary water driven rotor can both be installed or positioned in or near the chamber for additional power generation on such rotor axle or separate rotor axles, as suggested above, along with a potential for supplementary energy output in addition to that generated by main rotor member. Such secondary rotors, if deployed, can be affixed on the main rotor or water auxiliary rotor either in the shroud chamber just outside the shroud chamber and perhaps being positioned in the chamber facing the exit opening of the shroud chamber.

In summary and in general, the subject invention is based around a base housing member generally having any disposition and having a hollow internal chamber with a water inlet opening to admit water into such chamber, with a water movement powered turbine members located either in such chamber or outside such chamber, with the turbine blades of such bases rotor being positioned to receive any oncoming water movements through such chamber so as to rotate such base rotor around is longitudinal central axis.

Variously, in one of several alternate structural arrangements of subject device, the subject invention may have separate rotor means affixed on independent or secondary axles on different portions outside. This separate or secondary rotor means may also structured to and positioned to receive water forces flowing from water inside the chamber against such secondary rotor means. Thus, head-on water currents entering the chamber from the outside drive the secondary rotor or base rotor, thereby producing as stated forces in the overall mechanism. As discussed previously, the turbine rotor can be placed in the water and not be enclosed in a chamber housing.

In yet another general embodiment of the subject invention, structural means are deployed to utilize hydrostatic water pressure at lower levels of a body of water as funneling the water from lower depths into a enclosed hollow chamber, using the hydrostatic pressure to propel the water at a greater dynamic force into a separate spatial area or receptibles to drive a turbine, including a segregated tubular member into which hydrostatic pressure water flow if forced over a turbine.

In summary and in general, the subject invention is based around a base member generally of upright deposition and having a hollow internal chamber with an water inlet opening to admit water into such chamber and a water movement powered base rotor located either in such chamber or outside such chamber, with the rotor blades of such bases rotor being positioned to receive any water movements through such chamber so as to rotate such base rotor around its longitudinal central axis.

### DESCRIPTION OF SPECIFIC EMBODIMENTS OF SUBJECT INVENTION

The following description of one or more specific of the subject invention embodiments shall not be construed to limit the scope of the claims annexed hereto, as other embodiments may be considered to be in the scope of the invention herein. Therefore the following description will not be construed to limit the scope of the claims hereto, as there are several embodiments within the scope of the subject invention. The subject apparatus device which incorporates structural aspects of the invention herein is as an apparatus which is focused on a water flow or hydrostatic water pressure powered rotor mechanism, or other water means, such water driven rotor mechanism having a rotational member as installed within or adjacent to such mechanism in the water, such rotational member having water movement sensitive means to receive the impact of any oncoming water movement or water pressure, for generation of power, such water sensitive means generally being in the form of a rotor member for direct rotational drive of a shaft on which the rotor member is affixed herein, such rotor member being positioned facing generally the resultant oncoming water flow or water pressure, which leads to means to rotate a turbine, for ultimate generation of electrical or other forms of power.

In summarizing the general embodiment of the subject invention it is important to note, as is well known that structural devices driven for energy purposes, are all subject to and dependent on the vagaries of water force at a given time. In some areas, there is no real effective economic output from water sources for energy generation, because of little or no water flow, unless there is a dam with substantially consistent water flow. Further, in summer months in many areas the waters diminish dramatically. For these reasons, the methodology herein is deployed to increase water flow over water turbine rotors in the path of the water flow. In this light, the reductions in the water flow at any given time in the concepts herein, involve placement of a water turbine rotor in a position at the lower levels of w water body, will ensure available water flow for a turbine, even during times of low water levels.

The subject device which incorporates structural aspects of the subject invention is thus focused on a water powered rotor mechanism, specifically utilizing energy from water sources such as water current movements or hydrostatic water pressure primarily under the water surface to provide energy to drive a rotor mechanism, such apparatus comprising in some embodiments in a general structural arrangement a longitudinally extending housing structure with an internal longitudinally extending chamber of some longitudinal extent, or having other holdings or protective structures for the turbine. Such structure has a water intake opening at some position for water intake generally positioned at the frontal or upstream portion of the housing chamber and a water outlet opening positioned between the frontal, upstream portion of the structure and downstream rear portion of the structure.

Such frontal opening in such structure communicates with water outside the chambered structure to the central longitudinally extending chamber that extends rearwardly towards the posterior part of the housing chamber. The longitudinal extending chamber in one embodiment is formed to help accelerate the rearwind flow of the water in the chamber to the downstream exit opening, with a progressively decreasing chamber circumference as the housing channel extends rearwardly to the exit opening of the chamber. This latter structure helps to accelerate water flow through such internal chamber.

To this end, the water driven rotor mechanism can be positioned at or near the frontal portion of the housing chamber. Such rotor mechanism has a central rotational axle rotationally installed longitudinally through such chamber or adjacent to such chamber, with the rotational axle having means thereon in certain embodiments to drive auxiliary pressure reduction pumps inside the chamber. In some embodiments as stated above, the housing chamber is formed with a gradually decreasing diameter or perimeter to help increase the water flow through the Bernoullie effect. By reason of the partial vacuum and/or increased water flow speed in such chamber, water flow will increase by some degree as it moves into such chamber in front of the opening in the housing chamber and this increase in flow into the chamber is caused basically by reduced pressure created in the chamber by the mechanisms or processes outlined above, thereby increasing the water flow speed over the water driven rotor as so positioned in the chamber. The water flow over the rotor, once having passed over the frontal opening of the chamber, will pass through the chamber in a longitudinal manner and thence through the gradually narrowing chamber as it flows to the exit opening of the chamber and such water flow will help accelerate the water flow as such water flow passes through the gradually decreased circumference of the chamber. As indicated, to some degree these latter structural and hydrodynamic phenomena will help create an increased water flow in the chamber the upper stream portion of the chamber and thus accelerate and increase water flow through the housing chamber. This latter phenomenon will cause a relative increase in water flow speed into the housing chamber at the frontal opening of the shroud chamber, near which is positioned the rotor turbine blades.

Thus, the idea herein is to employ means to create a an increase of water flow, relative to the normal flow of water in the particular body of water flow so that water is more readily drawn into the chamber because this in turn, will increase the water flow over the turbine blades and improve the efficiency of the water driven rotor member Additionally, the use of a housing chamber will decrease the chance of water born objects such as logs or other object striking against the rotor blades. A housing, with a chamber, for the water driven turbine can be avoided if there is alternate support and protection means for the turbine structure.

Alternately stated, the subject apparatus incorporating features of the subject invention is directed to a water powered rotor mechanism, preferably having an open chamber positioned over or near the water driven rotor, such apparatus comprising in its general form a shroud or housing member having a partially enclosed chamber with an water intake opening at the frontal end of such housing and an water exit opening at some other portion of the shroud. In this general embodiment of the subject invention, the turbine member is positioned in the water forward of any housing member, and not inside thereof. The opening end of the chamber or housing will be positioned ideally at or near the water driven rotor member. Thus, when oncoming water reaches and impacts against the water driver rotor frontally, such impacting water will thence substantially pass directly into the chamber housing, since the rotor will be ideally positioned just in front of entrance opening of the chamber, and as such water passes into the chamber it will be almost immediately be subjected to the gradually decreasing diameter of the chamber housing as water passes through such chamber. Such moving water in the chamber will increase the water flow into and intensity at or near the frontal end of the chamber and will create in effect of decreased water pressure in the rear portion of the chamber, and secondary turbines can be optionally positioned inside the housing. This will continue as water is pulled into the front of the chamber and thereby help increase the water flow continuously near the frontal rotor member outside the housing.

The housing chamber is exposed to outside water and for this purpose is ideally aligned parallel, as to its longitudinal central axis, to the direction of flow prevailing waters and is structurally adapted to admit water flow into the longitudinal extending chamber as aligned with the prevailing water flow. For this purpose the housing chamber can be mounted in a substantially horizontal plane about a vertical axis to be freely movable about such axis for alignment with the existing and potentially variable water direction. A portion of the chamber can be structured to receive and potentially support the water turbine rotor axle near the middle inside portion or other portions of the housing chamber, such rotor axle mechanism having a central rotational axle rotationally installed preferably along or parallel to the longitudinal central axis of such chamber, and extending longitudinally into such chamber with such rotor member anchored in such chamber for free rotational movement in such bearing member or members. As indicated, one or more secondary water driven rotor can both be installed or positioned in or near the chamber for additional power generation on such rotor axle or separate rotor axles, as suggested above, along with a potential for supplementary energy output in addition to that generated by main rotor member. Such secondary rotors, if deployed, can be affixed on the main rotor or water auxiliary rotor either in the shroud chamber just outside the shroud chamber and perhaps being positioned in the chamber facing the exit opening of the shroud chamber.

In summary and in general, the subject invention is based around a base housing member generally having any disposition and having a hollow internal chamber with a water inlet opening to admit water into such chamber, with a water movement powered turbine members located either in such chamber or outside such chamber, with the turbine blades of such bases rotor being positioned to receive any oncoming water movements through such chamber so as to rotate such base rotor around is longitudinal central axis.

Variously, in one of several alternate structural arrangements of subject device, the subject invention may have separate rotor means affixed on independent or secondary axles on different portions outside. This separate or secondary rotor means may also structured to and positioned to receive water forces flowing from water inside the chamber against such secondary rotor means. Thus, head-on water currents entering the chamber from the outside drive the secondary rotor or base rotor, thereby producing as stated forces in the overall mechanism. As discussed previously, the turbine rotor can be placed in the water and not be enclosed in a chamber housing.

In yet another general embodiment of the subject invention, structural means are deployed to utilize hydrostatic water pressure at lower levels of a body of water as funneling the water from lower depths into a enclosed hollow chamber, using the hydrostatic pressure to propel the water at a greater dynamic force into a separate spatial area or receptibles to drive a turbine, including a segregated tubular member into which hydrostatic pressure water flow if forced over a turbine.

In summary and in general, the subject invention is based around a base member generally of upright deposition and having a hollow internal chamber with an water inlet opening to admit water into such chamber and a water movement powered base rotor located either in such chamber or outside such chamber, with the rotor blades of such bases rotor being positioned to receive any water movements through such chamber so as to rotate such base rotor around its longitudinal central axis.

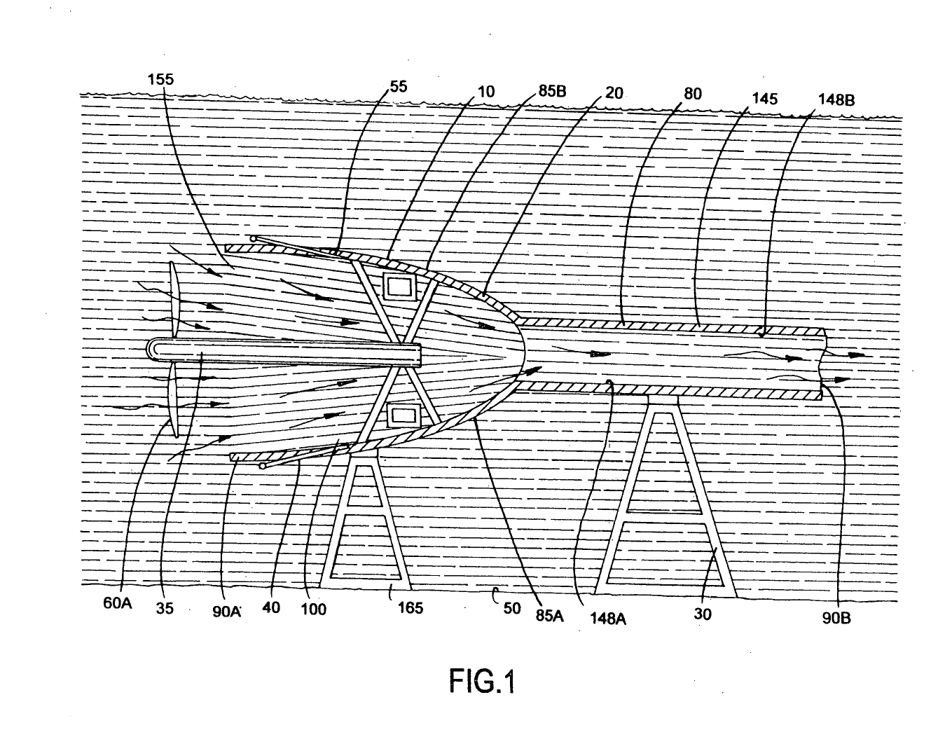

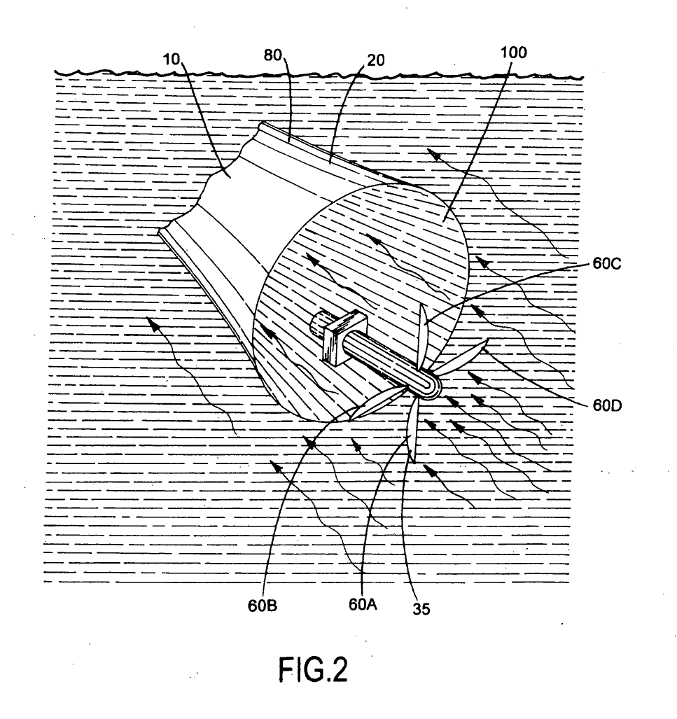

As a preface to the following description, it is important to note that the subject invention may involve several different embodiments. As to specific embodiments of the subject invention, reference is had to the drawings and particularly FIGS. 1 and 2 shown is a water turbine support structure 10 in a generally structural arrangement. This first discussed embodiment is one that includes use of a chambered housing 20, in which the turbine is deployed in chamber 25 in the housing as described above. Specifically shown as comprising such overall housing structure is a base support member 30 with a lower base portion 36 and an upper portion 37 on or in which a water driven turbine 35 is mounted. The turbine member 30 is positioned generally and situated in a position on the bottom of the base support member 40 so that turbine rotor is postured ideally, but not critically, with the rotor turbine parallel to the bottom 42 of the water body 44 and at a distance above the bottom of the water body to capture the maximum effects of the water flow. The base support member may be a tower affixed in the water or other man made structure or it may in fact be supported on a natural structure on the bottom of the water body. The base member may be positioned parallel to the bottom 42 of the water body 44, with appropriate bearing means, not shown, to support the rotor member for free axial rotational movement therein. The upper part 37 of the base support member on the upper can be above or underneath the water body surface 48. This invention is applicable however, any-type of structure supporting a rotor shaft of sufficient durability to support the turbine at a level significantly below the water.

The water turbine blades 60A, 60B, 60 C and 60D are affixed to rotor shaft 45 in such a manner that the water turbine preferable projects directly and frontally towards the oncoming water and thus, specifically extends frontwardly and generally and are disposed perpendicularly to the upper water surface with the longitudinal axis of the water turbine rotor preferably aligned with the flow of any prevailing water flow. For this purpose the rotor shaft member, as mounted through bearing surface elements in base support member 30 can rotate about a horizontal axis in a substantially horizontal plane or a horizontal axis. The rotor shaft can be thence interconnected to a generator off shore not shown, utilizing the rotational movement of the turbine 35 as the energy source. As seen the rotor water turbine blades 60A, 60B, 60C and 60D on rotor 25, as mounted, are fairly conventional in structural arrangement, as thus far described.

One specific embodiment of the subject invention, as described above, among several potential embodiments, attention is directed to the drawings, including FIGS. 1 and 2 in which the water enhancement base structure 10 is shown. Water flow enhancement base structure 10 is preferably, but not essentially, a housing structure being in the form of longitudinally extending member 80 that has a lower surface portion 85A and an upper surface portion 85B. The housing 80 additionally has a first end 90A and a second end 90B, with the first end 90A considered to be the frontal portion or water facing portion. Inside such housing 80 is an internal longitudinally extending hollow or chamber 100. Such chamber 100 in the specific embodiment described herein is basically a longitudinally extending spatial area within such housing extending generally, but not essentially, from the first end 90A to the second end 90B of chamber 100. Chamber 100 is disposed preferably, but not necessarily, aligned along the longitudinal for a description of one specific embodiment of the subject invention, among several as shown in the drawings, including the one shown in FIGS. 1 and 2. The overall water flow enhancement base structure is preferably, but not essentially, a housing structure 145 formed as a longitudinally extending housing 145 that has a lower surface portion 148A and an upper surface portion 148B. Additionally the housing flow 145 has first end 144A and the second end 149B, with the first end 149A considered to be the frontal portion or water flow facing portion. Inside such housing 145 proper is an internal longitudinally extending hollow or chamber 200. Such chamber 900 in the specific embodiment described herein has basically a longitudinally extending spatial area within such housing extending generally, but not essentially, from the first end 148A to the second end 148B of chamber 100 in housing 145. Chamber 900 is disposed preferably, but not necessarily, aligned along the longitudinal disposition of such housing 145 and is preferred to be aligned generally with the prevailing water flow patterns, although this latter characteristic is not critical to implementation of the subject invention. Alternately, the disposition of such shroud housing 145 and is preferred to be aligned generally with the prevailing water flow patterns, although this latter characteristic is not critical to implementation of the subject invention.

If the base support member for the housing 145 is utilized for a supportive structure, the lower portion of the base support member will generally be firmly affixed by some means to the river bottom. This invention is applicable however, any type of structure supporting a turbine and turbine rotor shaft, such as a vertically standing tower, or base, which is of sufficient strength as height to support the turbine at a level significantly above the water bottom so that the turbine rotor member is successfully high enough in the water to capture the maximal current effect. The turbine or housing need not be affixed to the river bottom and may be suspended downwardly from a barge member in which the barge is equipped with a generator, or alternately the housing 145 with a rotor disposed therein may be suspended downwardly into the water body from a tower member, which is affixed in the water body or is positioned on a nearby shore. The tower member may be equipped with means to raise or lower the housing or base support member for the turbine, in and out of the water needed for maintenance, repair.

As indicated, in one embodiment, the water turbine blades 60A, 60B, 60C and 60D are affixed to the turbine rotor shaft, as supported on bearing members integrally affixed to the base member 30 in such a manner that the water turbine 35 preferable projects directly and frontally towards the oncoming water and thus, specifically extend frontwardly and generally perpendicularly to the upper water surface with the longitudinal axis of the water turbine rotor being preferably aligned with the direction of any prevailing water flow. For this purpose, the rotor shaft member, as mounted through the bearing surface elements in base support member 30, can rotate about a horizontal axis in a substantially vertical plane on a horizontal axis. The rotor shaft can be thence be interconnected indirectly through to a generator off shore not shown, utilizing also the rotational movement of the secondary rotor shaft as the energy source. As seen in the drawings, the rotor water turbine blades 60A, 60B, 60C and 60D, as mounted, are fairly conventional in structural arrangement, as thus far described as seen in the drawings

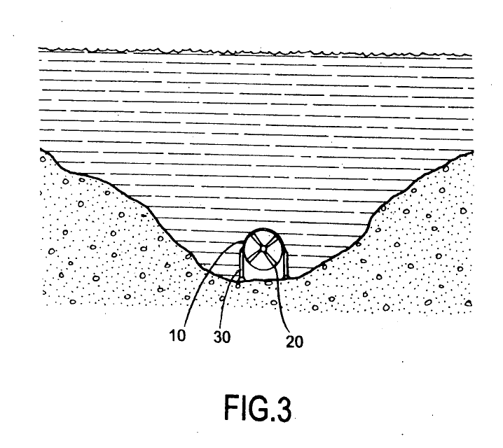

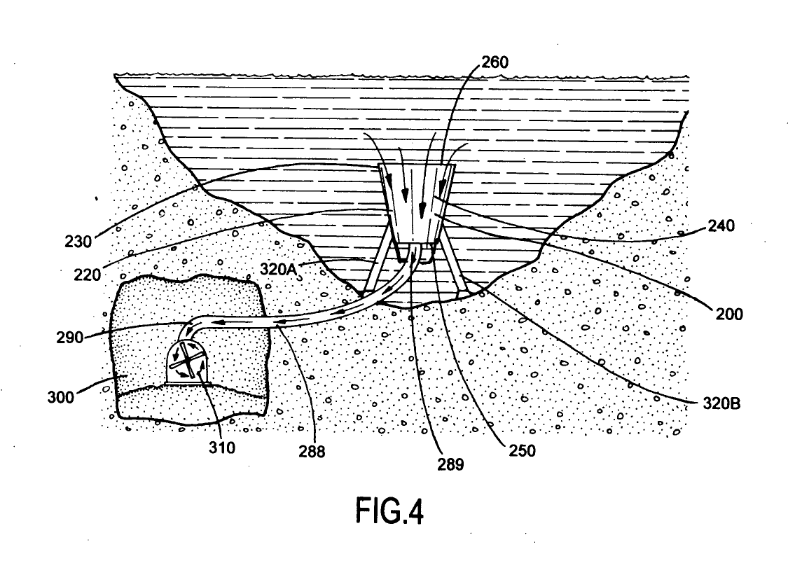

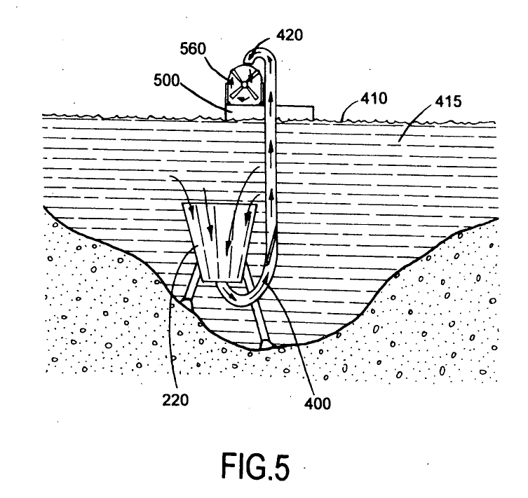

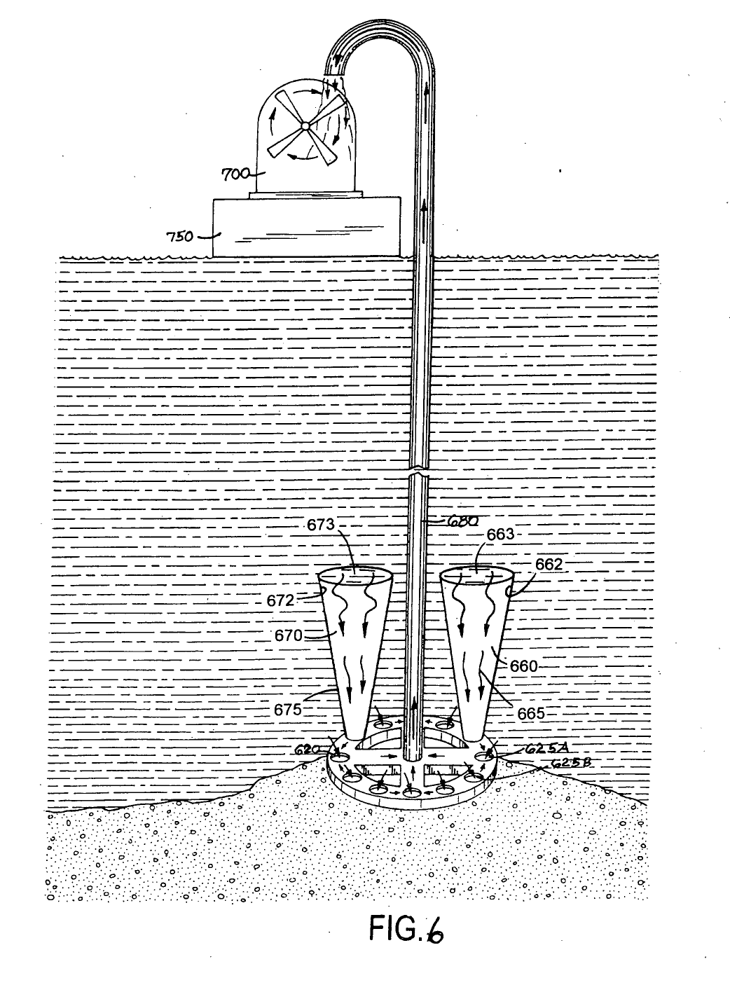

For a description of another specific embodiment of the subject invention, among several, attention is directed to the drawings, including FIGS. 4 and 5 a water collection structure 205 is shown. Water collection structure 205 is structured to utilize hydrostatic water pressure in a given body of water. Water collection base structure 205 is preferably located substantially below the water surface to receive water into an open water collection crucible 220, which is open at a top rim area 230 to receive any downwardly imposed hydrostatic water pressure, in the water body 26 as schematically shown in FIG. 3. Such crucible has an open inner portion that has a lower surface portion 250 and an upper opening 260. The lower surface portion of the open crucible has an opening on the bottom portion to eject water out of the crucible connected to a flexible or inflexible pipe 270 with the first end of such pipe integrally affixed to the bottom opening of the crucible to receive the water ejected from the crucible due to hydrostatic water pressure, and which pipe is projected or positioned on the second end 290 of such pipe to feed the flow of water through such pipe into a cavern or other chamber, such as cavern 300 located under or near the shore of the water body. As seen in such cavern 300, there is a water turbine 310 over which the flow of water coming down the pipe from over s propelled over the turbine to generate electricity. In one embodiment the water collector crucible 220 is supported by legs 320A and 320B on the bottom floor of the water body.

In another embodiment, the crucible 220 is positioned in a water body in the same manner as the crucible shown in FIG. 3. In the embodiment shown in FIG. 3, a pipe member 400 is connected to the opening on the bottom of the crucible, but with the pipe member 400 being projected upwardly to the upper surface of the water body with the upper or second end 420 of the pipe member being held upwardly by a floating platform 500, such as a barge, as seen in FIG. 5. The upper end of pipe 400 can be curved approximately one hundred and eighty degrees with the second at the second end being adapted to project water flow downwardly over a turbine 560 on platform 500 to rotate the rotor shaft and turbine member as disposed in a chamber 540 that is adapted to house the turbine assembly.

In summary, the subject invention is a structure for increasing the ambient water flow to drive a rotor mechanism comprising:

(a) a housing member having a frontal surface and a rear surface, such housing member having an internal chamber within such housing member, with such housing member having a frontal surface, an inlet opening to admit water flow into such chamber, and wherein such housing chamber has an outlet opening and a water outlet opening, such water outlet opening being located posterior to such water inlet opening to eject water from said chamber.

Another summary is that the subject invention is a structure for harnessing water currents to drive a rotor mechanism comprising:

(a) a housing member having an outer surface, such housing member having an internal chamber with such housing member, having a frontal wall inlet opening;

(b) water outlet means on such housing member, such water outlet means extending from areas inside such chamber to spatial areas outside such chamber;

(c) water-driven rotor member having a central rotatable axle affixed to a position adjacent such water outlet means, such rotor-driven member having a rotor blade affixed to a portion of such rotatable axle for receiving incoming water and wherein such rotor means has additional rotor blades to receive the impact of water escaping from such chamber in such housing.

Furthermore, the subject invention can be summarized as a combined solar powered and water powered rotor mechanism comprising

(a) a housing member, such housing member having an internal longitudinally extending chamber, disposed with side such housing member, and wherein such housing member has an water inlet opening therein which extends from spatial areas outside such housing into such chamber, and wherein such housing has an water outlet opening to vent water from such chamber;

(b) a rotor mechanism having a plurality of vane members to receive the impact of water vented from such water outlet opening and drive said rotor mechanism.

In further summary, the subject invention is a rotor apparatus structured to be driven by water force and solar energy comprising:

(a) a housing member with an internal chamber with an upper portion and a lower portion, said housing member having a translucent front surface portion on the outside of solar chamber and a solar absorptive back surface portion with a solar energy collector chamber within such housing, with such chamber being disposed between such front surface portion and such back surface portion, such housing member having an water intake opening on the lower portion of such housing;

(b) rotatable shaft means rotatably mounted through such housing member with a portion of such shaft;

(c) water driven rotor means disposed concentricity on that portion of the rotatable shaft that projects frontally of the front surface, and further comprising;

(d) water driven means disposed on that portion of the rotor shaft in the chamber.

Further summarizing, the subject invention is a structure for augmenting water flow over a water turbine comprising:

(a) a housing member having an upper surface and a lower surface, said housing member having an internal chamber within said housing member, with said housing member having an water inlet opening and an water outlet opening said water outlet opening connecting with said chamber and said water out outlet opening connecting with said chamber;

(b) water driven turbine means affixed on a rotor shaft, said water driven turbine means being positioned adjacent to said water inlet opening to said chamber to receive water movement from water outside said chamber onto said water turbine means.

In still another summary of the subject invention, the invention is a structure for augmenting water flow over a water turbine comprising:

(a) a housing member having an upper surface and a lower surface, such housing member having an internal chamber within such housing member, with such housing member having an water inlet opening and an water outlet opening such water outlet opening connecting with such chamber and such water out outlet opening connecting with such chamber;

(b) water turbine means affixed on a rotor shaft, such water turbine means being positioned adjacent to such water inlet opening to said chamber to receive water movement from water outside such chamber onto such water turbine means;

Further, the subject invention is a structure for utilizing water currents to drive a rotor mechanism comprising:

(a) a housing member having an internal chamber formed in part by a first outer surface on such housing and a second outer surface;

(b) a housing member having an outer surface, such housing member having an internal chamber with said housing member having a frontal wall comprising the enclosure to said chamber;

(c) water outlet means on said housing member, such water outlet means extending from areas inside said chamber to spatial areas outside said chamber;

(d) water-driven rotor member having a central rotatable axle affixed to a position adjacent said water outlet means, said rotor-driven member having a rotor blade affixed to a portion of said rotatable axle for receiving incoming water and wherein such rotor means has additional rotor blades to receive the impact of water escaping from such chamber in said housing.

In yet another embodiment of the subject invention may be incorporated a base structure generally having an interior portion which is hollow and which interior is adapted to receive water flow intake from the surrounding water body through one or more openings and when member has a water outflow member that collects and expels water from the interior to expel it to the upper surface of the body of water and over a turbine member disposed on a barge like member on the surface of the barge like member so that the water expelled onto the turbine.

More specifically, as to using hydrostatic water pressure in a body of water, the subject invention is formed in one specific embodiment of the subject invention as a base member 620 having an interior circular channel or channels that is completely encircled inside of the base member, with such channel chamber being of any shape or configuration as long as the chamber is capable of receiving hydrostatically imposed water on the upper surface of such base member. The upper surface of such base member has a plurality of openings 625A, 625B, each formed with upwardly projecting ventricles, somewhat shaped to receive the bottom portion of funnel members, such as open funnel members 675 and 665, adapted to receive hydrostatically pressured water through funnel upper openings 673 and 663 to permit such water to flow down into the open chambers 660 and 670 in such funnels. The open chambers 670 and 660 of funnel 675 and 665 respectively are gradually tapered from upper portions 670 to 662 into a more restrictive and narrowed space at the bottom of such funnel chambers to enhance and increase the velocity of the water flow to the bottom of such funnel. The bottoms of such funnels are open at the bottom to feed the water flow into one of the openings in the upper part of the base member such as openings 625A and 625B. The upper portions of the funnel members are open and the funneled members are adapted to receive water from above as the base member is immersed at the bottom of the water. The water inside the chamber in base member 620 is then forced into the vertical tubular member 680 by hydrostatic pressure, which water is thence propelled upwardly into the projecting tubular member which extends above the water surface, with water flow forced downwardly at the upper opening, and the resultant water flow out of such tubular member 680 is propelled downwardly over a turbine 700 on a barge 750, or other support means above the water.

As a result, the water in the base member is propelled upwardly through the vertical tubular member 680 connecting in the base member 620 into the upper part of the tubular member and up to a platform member on the water surface, to drive a turbine, as shown, on such platform or barge. The air pressure or atmospheric pressure at the water surface level, at the opening of the upright tubular member yields a pressure differential that will enable the flow of water up through the vertical tube to the barge. Numerous check valves may be affixed in the vertical tube 680 help enhance the upward flow of water in tubular member 680.

By the very nature of the apparatus water is propelled upwardly proportionately to the differentiated water pressure at the bottom of the body of water relative to the atmospheric pressure at the barge or platform above the surface of the water. This pressure differential is represented mathematically as

$$\frac{P 1}{P 2}$$

where P1 is the hydrostatic pressure of P2 the body of water at the bottom are and P2 equals the atmospheric pressure of the surface at the above level in the water surface.

Therefore, the resultant pressure differential is represented by P1-P2, and the proportional ratio will be

$$\frac{P 1}{P 2} .$$

As stated, in order to help propel the water at the level upwardly, the hollow base member is equipped with one way valves which propel upwardly at angels perpendicular inwardly towards the center of such tube and upwardly. Various embodiments other than the ones described above can be used to capture deep water hydrostatic pressure. Therefore, the hydrostatic based concepts described above can utilize other structural concepts.

1. A structure for augmenting water flow over a water turbine comprising:
(a) a housing member having an upper surface and a lower surface, said housing member having an internal chamber within said housing member, with said housing member having an water inlet opening and an water outlet opening said water outlet opening connecting with said chamber and said water out outlet opening connecting with said chamber;
(b) water turbine means affixed on a rotor shaft in said housing member, said water turbine means being positioned adjacent to said water inlet opening to said chamber to receive water movement from water outside said chamber to impart onto said water turbine means,
(c) means to eject said water from said housing member after passing over said water turbine means.

2. A structure for using hydrostatic water pressure in a body of water over a water turbine comprising:
(a) a water receiving container member having an upper surface and a lower surface, said container member having an internal chamber, with said container member having a water inlet opening extending from outside said container into said internal chamber to draw water into said internal chamber through hydrostatic pressure;
(b) pipe connection means affixed on a first end and connected to said internal chamber in said water receiving container to drain water collected into said internal chamber and pass such water to a separate location beneath said water receiving container, with said pipe connected means having a second end to project water received in such pipe connection means to a rotor member at said separate location.

3. An apparatus for converting the hydrostatic water pressure of an underwater zone comprising:
(a) an open crucible disposed in said water, said crucible having an open collection space shaped with a narrowed bottom area relative to the upper area, with said open area being on the crucible being faced upwardly, said crucible having a lower exit opening to eject water collected therein;
(b) pipe means connected to said exit opening and extending upwardly to the upper surface of the water body to project water collected in said turbine rotor positioned above the water surface.
